(19) United States
(12) Patent Application Publication
(10) Pub. No.: US 2025/0198827 A1
(43) Pub. Date: Jun. 19, 2025

(54) MOBILE FLUID METER TESTING AND PROFILING SYSTEM

(71) Applicants: David Bellamy Corey, Tampa, FL (US); Christopher Michael Mastic, Ocala, FL (US); Michael Louis Mastic, Tampa, FL (US); Jeffrey Brian Butt, Ocala, FL (US); Eric Cohee, Urbana, IN (US); Robbie Smart, Alachua, FL (US); Jonathan Jethro, Orlando, FL (US); Russ Lowrey, Ocala, FL (US)

(72) Inventors: David Bellamy Corey, Tampa, FL (US); Christopher Michael Mastic, Ocala, FL (US); Michael Louis Mastic, Tampa, FL (US); Jeffrey Brian Butt, Ocala, FL (US); Eric Cohee, Urbana, IN (US); Robbie Smart, Alachua, FL (US); Jonathan Jethro, Orlando, FL (US); Russ Lowrey, Ocala, FL (US)

(73) Assignee: OW Investors, LLC. (dba Mars Company), Ocala, FL (US)

(21) Appl. No.: 18/974,731

(22) Filed: Dec. 9, 2024

Related U.S. Application Data
(63) Continuation-in-part of application No. 17/532,149, filed on Nov. 22, 2021, now Pat. No. 12,163,822.
Application No. 17/532,149 is a division of application No. 16/424,477, filed on May 28, 2019, now Pat. No. 11,181,415.
(60) Provisional application No. 62/677,007, filed on May 27, 2018.

(51) Int. Cl. G01F 25/10

(52) U.S. Cl. CPC G01F 25/10

(57) ABSTRACT

This technology introduces a portable, mobile testing system designed to evaluate the accuracy of fluid flow meters directly at their installation sites, eliminating the need to remove meters for testing and saving time and resources. The system features an improved drain line system that ensures quick and complete removal of test fluid after testing is finished, minimizing cleanup and environmental impact. It also automates the testing process, evaluating the flow meter at various flow rates and collecting comprehensive performance data. This data is then recorded and securely transferred to a centralized database for analysis, reporting, and historical tracking. This portable system offers a convenient and efficient solution for on-site flow meter testing, improving accuracy and streamlining maintenance processes.

### CLAIM TO PRIORITY

This Application claims priority, as a continuation-in-part, to pending application Ser. No. 17/532,149 (to be patent 12,163,822), Fluid Meter testing and Profiling System, filed on 22 Dec. 2021, which claims priority to patent 11,181,415, Fluid Meter System and Associated A Posteriori Database, filed on 28 May 2019, which claims the benefit of provisional application 62/677,007, Fluid Meter Ceterification System and Associated A Posteriori Database filed on 27 May 2018, the entire content of which are incorporated by this reference by all that they disclose for all purposes. which are incorporated by this reference for all that they disclose for all purposes.

### TECHNICAL FIELD

The invention relates to the field of mobile fluid meter tests systems with enhanced electronic and Artificial Intelligence features. The invention relates to developing a centralized data collection platform in communication capable of interacting with a a plurality of test systems deployed in a plurality of locations for generating test data used to generate meter profiles and performance predictions for metering technology.

### BACKGROUND OF THE INVENTION

No fluid measuring device (uh water meter and a water meter test system) is ideal for providing error-free measurements. There will always be metering errors. The best one can do is develop a measurement process that provides repeatable results and adjust such a process over time to make it as accurate as possible. With regard to water meters used to measure water flow, every water meter, no matter its type, has limited measuring ability. Consequently, either part of the water consumption will not be registered (resulting in undercharging—lost revenue), or there will be an over-registration of the water consumption (resulting in overcharges). In either case, particularly in the area of metering water consumption, it is important to quantify the magnitude of such errors and determine what causes them so that entities purchasing water meters can make informed decisions regarding the type of meter to purchase in a particular environment. Such data collected from various trusted sources deployed in a plurality of locations using known-good data collection processes.

There are at least two basic types of data that are useful when considering the best item to purchase: (1) “laboratory” data and (2) field data. Laboratory data is simply data collected under controlled conditions. Measuring horsepower is a good example. However, it should be appreciated that horsepower values will not tell one how fast a vehicle will be on a given track. For such information, one needs field data. Field data is data collected from an item under normal use or after normal use. Thus, laboratory data predicts how an item will work in the real world, while field data tells one how an item actually works in the real world.

Currently, there is a general lack of organized information regarding laboratory data and field data with regard to water meters that could be used to provide insight into the real effect of environmental parameters on the performance of water meters. Such information would allow w utility personnel responsible for selecting metering technology to evaluate or estimate water meter accuracy for a target environment. Further, what has been clearly indicated from experiments and real-life experience is that not every water meter has the same sensitivity to the environmental parameters that affect meter accuracy over time. Thus, selecting the most adequate metering technology type (based on laboratory data/manufacturer specifications) and the proper construction that best suits the target environment (i.e., the specific characteristics of the water supply system) is important.

What is needed is a data collection system comprising both field and laboratory data related to the factors that can affect water meter accuracy for both domestic and industrial meter types. One way to assemble such information is to create a centralized data storage system generated from a plurality of trusted sources using verified data collection processes and equipment in a plurality of environments.

MARS® Company is a renowned pioneer in fluid meter test bench technologies. As a leader in water meter testing, MARS® offers a range of testing solutions. Their small meter gravimetric test system is a prime example, capable of testing multiple meters simultaneously (e.g., 20, though this can vary). The meters are connected in series, with the first meter's input connected to the system's fluid source and the last meter's output connected to a measuring tank that typical rests on highly accurate scales. This allows for efficient testing of multiple meters, saving time.

MARS is also known for its mobile/portable meter testers for testing meters installed in the field. Our portable meter testing systems are designed to be mounted on a variety of vehicles, including utility trucks, pickup trucks, vans, and trailers, giving you the flexibility to conduct tests wherever needed. The system uses advanced comparison meter technology, with a fully linearized and calibrated design for the highest accuracy. This allows you to test meters in the field without removing the meter from its operating location, improving efficiency and minimizing disruption. Such technology is described in detail in commingly owned U.S. Pat. No. 11,371,873.

Notably, anyone can operate a “test system” and generate “data.” What is needed is a system that can track the equipment and associated “system” used to generate data. For water meter testing, what is needed is a system designed to meet or exceed the rigorous standards set by leading industry organizations. Examples include complying with the American Water Works Association (AWWA) recommendations to ensuring your testing aligns with best practices for water utilities. The system should also ensure that it meets standards such as the National Institute for Standards and Technology (NIST) Handbook 44 Specifications guaranteeing accuracy and traceability in your measurements. Meeting ISO Specifications for international standards for quality and performance is another similar goal.

The present invention teaches an improved portable test system in communication with a centralized data collection platform in communication capable of interacting with a a plurality of test systems deployed in a plurality of locations for generating test data used to generate meter profiles and performance predictions for metering technology. The improvements include hardware enhancements and software enhancements such Artificial Intelligence features that can track at portable tester's location, prompt the user where the meter to be tested is located, and configured the software system for the test the AI determines is requires from accessing a remote database.

### SUMMARY OF THE INVENTION

Some of the objects and advantages of the invention will now be outlined in the following description, while other objects and advantages of the invention may be obvious from the description or may be learned through the practice of the invention.

Broadly speaking, a principle object of the present invention is to provide a portable/mobile test bench apparatus and method for testing fluid flow meters.

Another object of the present invention is to provide a portable/mobile test bench apparatus and method for testing fluid flow meters where the apparatus comprises improved drain lines configured to remove the test fluid after testing is complete.

Still another objection object of the present invention is to provide a portable/mobile test bench apparatus controller comprising a processing device that is in communication with a remote centuralized database with an AI user interface ot enhance testing speed and accuracy.

Additional objects and advantages of the present invention are set forth in the detailed description herein or will be apparent to those skilled in the art upon reviewing the detailed description. Also, it should be further appreciated that modifications and variations to the specifically illustrated, referenced, and discussed steps or features hereof may be practiced in various uses and embodiments of this invention without departing from the spirit and scope thereof by virtue of the present reference thereto. Such variations may include, but are not limited to, the substitution of equivalent steps referenced or discussed and the functional, operational, or positional reversal of various features, steps, parts, or the like. Still further, it is to be understood that different embodiments, as well as different presently preferred embodiments, of this invention may include various combinations or configurations of presently disclosed features or elements or their equivalents (including combinations of features or parts or configurations thereof not expressly shown in the figures or stated in the detailed description).

Upon review of the remainder of the specification, those of ordinary skill in the art will better appreciate the features and aspects of such embodiments, and others.

### BRIEF DESCRIPTION OF THE DRAWINGS

A full and enabling description of the present subject matter, including the best mode thereof, directed to one of ordinary skill in the art, is set forth in the specification, which refers to the appended figures, in which:

FIG. 1 is a top plan view of an exemplary fluid meter test bench;

FIG. 2 is a side elevation view of an exemplary fluid meter test bench;

FIG. 3 is a block diagram representation of a plurality of test benches associated with a centralized storage system.

FIG. 4 is a top plan view of an exemplary fluid meter comprising a register and housing;

FIG. 5 is a side elevation view of the meter in FIG. 3;

FIG. 6 is a partially exploded side perspective view of an exemplary meter housing (minus the bottom plate) and internal measuring components (no register) associated with a tracking element; and

FIG. 7 is a side perspective view of an exemplary meter with a tracking element associated with the housing and register.

FIG. 8 is a front elevational prespective view of a mobile fluid meter tester;

FIG. 9 is a front elevational view of a mobile fluid meter tester;

FIG. 10 is a side elevational view

FIG. 11 is a back elevational view

Repeat use of reference characters throughout the present specification and appended drawings is intended to represent the same or analogous features or elements of the present technology.

### DISCLOSURE OF THE INVENTION

### Detailed Description

Reference now will be made in detail to the embodiments of the invention, one or more examples of which are set forth below. Each example is provided by way of an explanation of the invention, not a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent the same or analogous features, elements, or steps. It is to be understood by one of ordinary skill in the art that the present discussion is a description of exemplary embodiments only and is not intended to limit the broader aspects of the present invention.

### Construction Aids

For the purposes of this document, two or more items are “mechanically associated” by bringing them together or into a relationship with each other in any number of ways, including direct or indirect physical “releasable connections” (snaps, screws, Velcro®, bolts, etc.—generally connections designed to be easily and frequently released and reconnected), “hard-connections” (welds, gluing, rivets, macular bonds, generally connections that one does not anticipate disconnecting very often if at all and that is “broken” to separate), and/or “moveable connections” (rotating, pivoting, oscillating, etc.).

Similarly, two or more items are “electrically associated” by bringing them together or into a relationship with each other in any number of ways, including (a) a direct, indirect, or inductive communication connection and (b) a direct/indirect or inductive power connection. Additionally, while the drawings may illustrate various electronic components of a system connected by a single line, it will be appreciated that such lines may represent one or more signal paths, power connections, electrical connections and/or cables as required by the embodiment of interest.

For the purposes of this document, unless otherwise stated, the phrase “at least one of A, B, and C” means there is at least one of A, or at least one of B, or at least one of C or any combination thereof (not one of A, and one of B, and one of C).

As used herein, unless stated otherwise, the terms “first,” “second,” and “third” may be used interchangeably to distinguish one component from another and are not intended to signify the location or importance of the individual components.

As used herein, the terms “upstream” and “downstream” refer to the relative location of components in a fluid pathway. For example, component A is upstream of component B if fluid flows from component A to component B. Conversely, component A is downstream of component B if component A receives a fluid flow from component B.

An a posteriori database contains data based on experience or empirical evidence accumulated from testest systems. Notably, an a posteriori database may also include a priori knowledge and entries. As used in the claims, the definite article “said” identifies required elements that define the scope of embodiments of the claimed invention, whereas the definite article “the” merely identifies environmental elements that provide context for embodiments of the claimed invention that are not intended to be a limitation of any claim.

This document includes headers that are used for place markers only. Such headers are not meant to affect the construction of this document, do not in any way relate to the meaning of this document, nor should such headers be used for such purposes.

### DESCRIPTION

While the particulars of the present invention and associated technology may be adapted for use with any system configured to measure a parameter, the examples discussed herein are primarily in the context of test benches configured to verify the accuracy of fluid meters such as water meters.

Embodiments of the present invention relate to a platform 10 configured for evaluating and profiling metering technologies from information derived from a plurality of fluid meter test systems 12 deployed in a plurality of environments and in communication with a centralized data storage system 14.

### Prior Art Test Benches

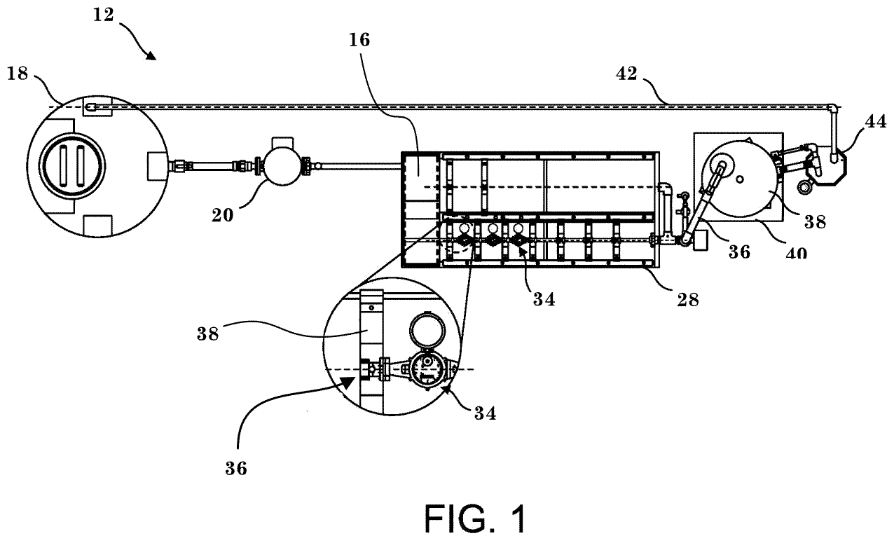

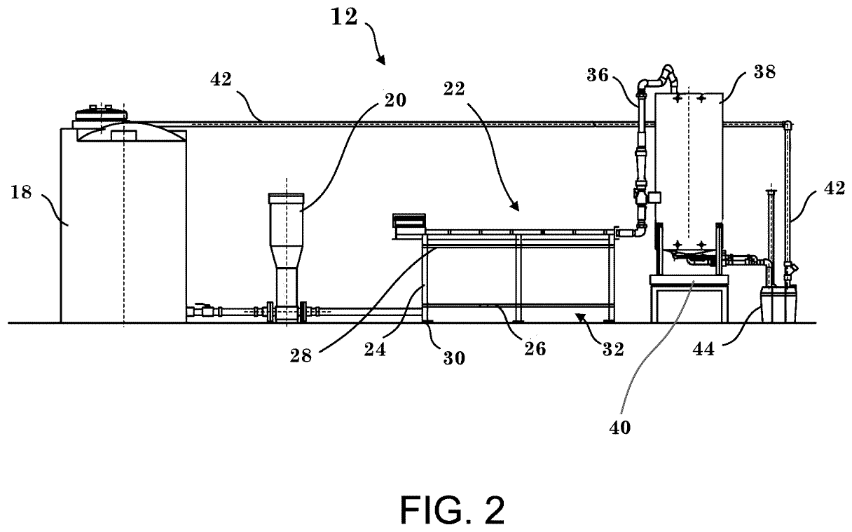

It seems useful to initially consider a fluid meter test system used to collect real-world meter data. It should be appreciated that much (but not all) of the fluid meter test bench system technology depicted in FIG. 1 and FIG. 2 has been developed over the past forty-plus years by the applicant, who started developing fluid meter test bench systems in the early 1980s. As is well known, fluid meters are configured to measure the volume of a fluid flowing through the meter. Utility companies use fluid meters to measure fluid consumption for billing purposes. Such fluid meters require testing to verify accuracy. A fluid meter test system pushes fluid through both a fluid Meter-Under-Test (MUT) and a very accurate “reference meter.” Restated, all the fluid that flows during a test flows through both the MUT (meter under test) and a reference meter. The reference meter is configured to generate a very accurate reference-volume reading (which is considered to be the correct reading). The MUT measures the volume of fluid that flows through its measuring chamber and generates a MUT-volume reading. Ideally, the reference-volume reading is perfectly accurate. If a MUT is also perfectly accurate, the MUT volume reading will be identical to the reference volume reading. How much the MUT volume reading varies from the reference volume reading is considered the MUT metering error. Further, a fluid meter would ideally have the same meter error at all flow rates. However, in the real world, the meter error is different depending on the flow rate, and a fluid meter may measure a 2 gallons/minute flow rate more accurately than 5 gallons/minute flow rate (for example). Thus, meters are typically tested at a plurality of flow rates.

Arguably, the most accurate way to test water meters is with a gravimetric system. Thus, the “reference meter” described above is actually a gravimetric system that generates the previously described reference-volume reading. While called a gravimetric system, such a system may use both gravimetric and volumetric technologies.

This document focuses on a mobile/portable tester (100) that utilizes advanced comparison meter technology for enhanced accuracy. The system features a fully linearized and calibrated design, employing highly accurate meters to generate a “reference reading.” This reference reading serves as a benchmark against which the meter under test is compared. The system is in communication with a remote centuralized database to provide meter profiling and advanced Artificial Intelligence (AI) features.

### Centuralized Database and Profiling

Referring now to FIG. 1 and FIG. 2. Such figures illustrate an electronically controlled Test Bench System (12) designed to assess the accuracy of fluid flow meters, specifically using water in this example. This system features a control console (16) housing the necessary components for automated operation: control wiring, a computer, and scale interface hardware. These components form a controller (16) that manages the testing process and provides an interface for both computerized and manual tests.

The system includes a source tank (18) with sufficient water capacity for testing (e.g., 200 gallons). This tank feeds a supply pump (20), which in turn delivers water to the test bench (22).

As best seen in FIG. 2, test bench (22) consists of multiple vertical support rails (24) connected to lower (26) and upper (28) support rails. The lower support rails (26) are strategically positioned on the vertical supports (24) to create a toe space (32) at the base. During testing, water from the source tank (18) is pumped through the meter under test (MUT 34) and an output path (36) into a measurement tank (38). This tank sits atop scales (40) that record the weight of the water. This weight measurement provides a precise reference volume, which is then compared against the volume readings from the MUTs (34) to evaluate their accuracy.

After the reference-volume has been measured and the test is complete, the fluid in measurement tank 38 is drained via return lines 42 and returned to the source tank 18 using return pump 44, allowing the fluid to be reused in subsequent tests. One of ordinary skill in the art will appreciate, however, that the source tank 18 may be replaced with any suitable water source, and the test fluid may simply be drained from the measurement tank 38 and discarded, eliminating the need for return lines 42 and return pump 44.

As can be seen in FIG. 1, a plurality of MUTs 34 are connected in series, allowing the plurality of meters to be tested simultaneously. The input and output of each meter are associated with an adapter apparatus 36, which is further associated with a bench-to-apparatus interface 38 associated with a test bench flow path. Notably, the inputs and outputs of MUT 34 could be connected with a flow path defined by test bench 12 using typical prior art metering couplings; however, such requires much more work and time compared to using a specially made adapter apparatus for coupling a fluid meter to the fluid flow path of a test system.

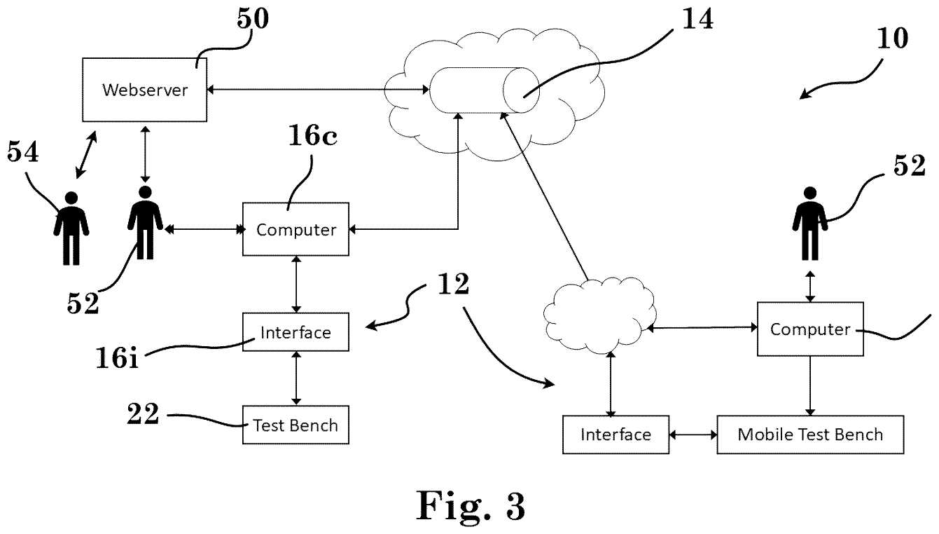

Reviewing now more particularly to FIG. 3, an exemplary platform 10 configured for evaluating and profiling metering technologies using information derived from a plurality of fluid meter test systems 12 deployed in a plurality of environments and in communication with a centralized data storage system 14 is presented. The platform 10 is in communication with a plurality of test bench systems 12 characterized by test system data and deployed in a plurality of environments. Each of the plurality of test bench systems 12 are configured with a controller 16 comprising a computing device 16c for automatically controlling its respective test bench system 12 to measure the accuracy of fluid meters 34. The computing device preferably defines an integral interface 16i or is in communication with an interface 16i that controls its respective test bench 22. Each controller is in communication with a centralized data storage system 14 either directly or indirectly via a device such as a webserver 50. A local user 52 with direct access to the controller 16 or remote user 54 connected to a controller 16 via a webserver 50 may conduct or monitor testing. Notably, a remote user 54 may be in communication with a webserver 50 or a centralized data storage system 14 using an application executed by a device such as a smartphone.

The test system software is loaded on each computing device 16c or is operably associated with each computing device 16c (e.g., software as a service). The test software is configured to provide a user interface to allow either a local user 52 or a remote user 54 to communicate with the controller 16 components to conduct fluid meter testing and generate meter data for the meters under test 34. For this document, meter data comprises meter type data, meter test data, and meter environmental data. The test system software is further configured to transfer at least part of the test system data and the meter data to a centralized data storage system 14, described in more detail below. It should be appreciated that the test system software may be loaded locally on computer 16c, or it may be software made available over a network via a “software as a service” system as well as a mixture of the two. Software as a service is simply software that is accessed over a network. The platform 10 is configured to use the centralized meter data and test system data to define a prior knowledge and derive a posterior knowledge to provide a profile for each meter tested.

As noted above, meter data may comprise meter type data, meter test data, and meter environmental data.

### Meter Type Data

The first data type considered is the meter type data. Exemplary meter type data is provided in Table 1 below.

TABLE 1
Meter Type Data

| Name | Description |
|---|---|
| Manufacturer | Who manufactured the meter |
| Manufactured Date | When the meter was manufactured |
| Date Placed in Service | When the meter was placed in service |
| Manufacturer Contact | Manufacturer website, phone contacts, |
| Information | electronic contacts |
| Meter Housing element | The material used to construct housing |
| | and housing ID number |
| Meter Register element | Type of register and date register |
| | associated with housing |
| Meter measurement | Type of measurement elements and when |
| elements | measurement elements were associated |
| | with housing |
| Meter transmitter | If a transmitter is present, transmitter |
| element | identifying information |
| Meter ID | Meter Identification Number |
| Meter Size | Size of the meter |
| Meter Type | Metering technology |
| K Factor | Correction factor |
| User Defined | Any data a user might wish to record and |
| | monitor |

As Table 1 above indicates, there are many meter parameters that fall under meter type data, including a housing element identifier, a measuring element identifier, a register identifier, and a transmitter identifier.

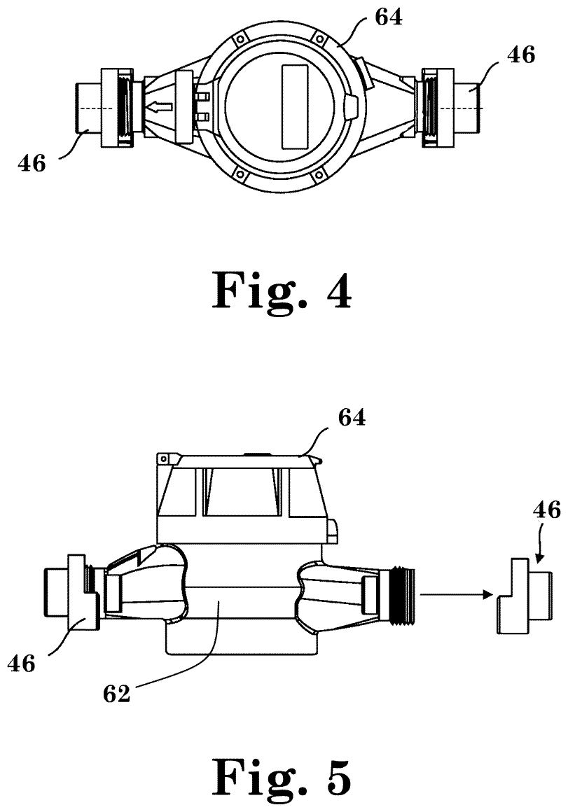

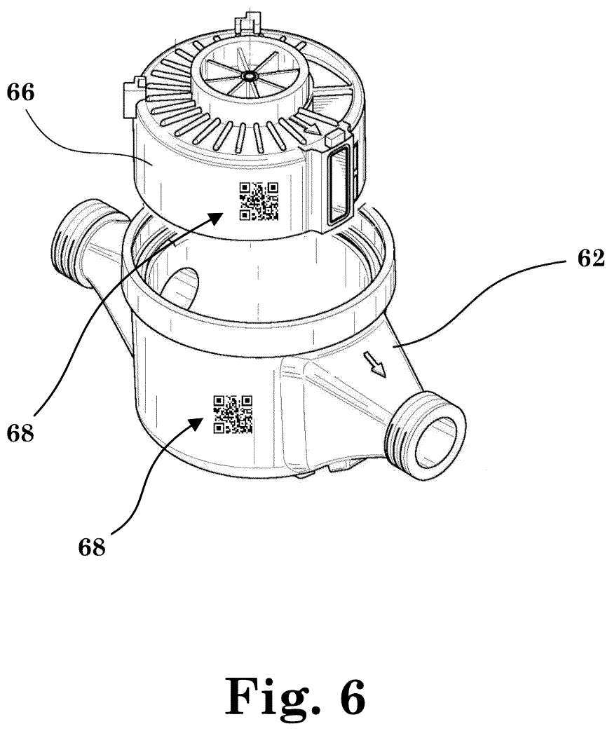

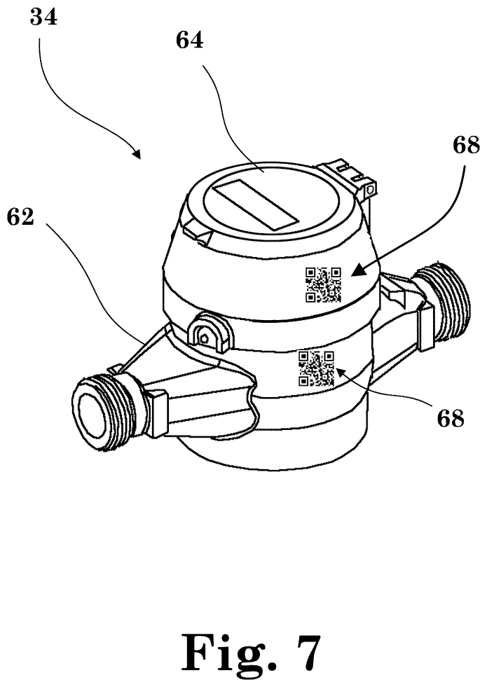

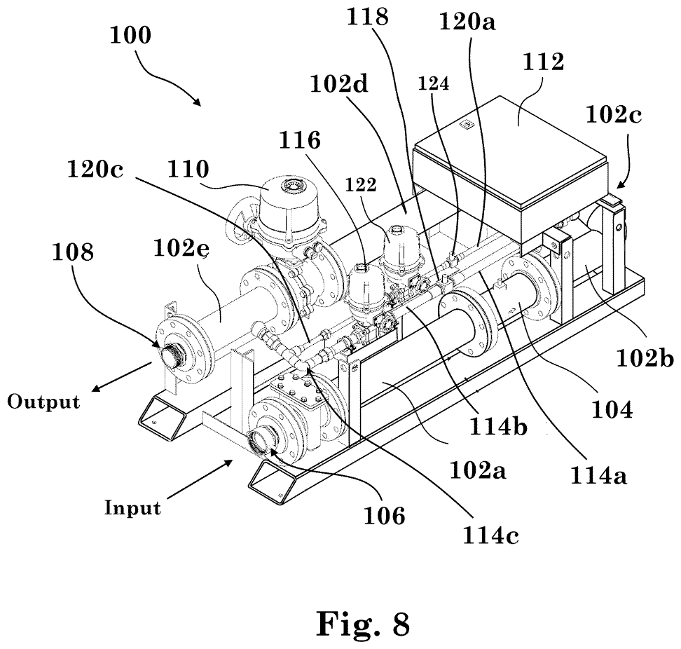

Referring now to FIG. 4 through FIG. 7, one feature of the disclosed technology includes optional tracking of meter components (i.e., sub-components). For example, as depicted in FIG. 4 through FIG. 6, for a typical water meter, such meter can be described as having three major components: (1) Housing element 62, (b) Register element 64, and (c) measuring element 66. For one embodiment of the disclosed invention, a tracking component 68 is associated with each meter sub-system. One advantage of tracking sub-components is the lower cost of “refurbishing” a meter. Here, a utility will only replace a sub-system of a metering device. For example, the water meter housings 62 is not removed from service, and one or more of the sub-components are changed, such as register 64 and measuring element 66. The assumption is that the housing 62 is significantly more durable than the register 64 and measuring element 66, and it is significantly more expensive to remove the entire meter than to replace the sub-components. However, such can affect the accuracy of meter data if not tracked. Based on the example above, the register 64 and the measuring element 66 may be called “wearable” components.

Additionally, tracking sub-component performance allows for tracking at least (a) the performance, (b) the mean time between failures, and (c) the expected life span of the wearable components. Such information can be used to alert the approaching end of life of a meter sub-component. Another benefit of tracking sub-components is that one is more confident about the sub-components defining a metering unit. It should be appreciated that not all sub-components are compatible with each other. For example, not all measurement components 66 are compatible with all housing elements 62, and not all registers 64 can be correctly coupled with all measurement components 66. Should the incompatible sub-components be associated in a metering unit, such a metering unit will provide inaccurate measurement data. Thus, for the preferred embodiment, the housing tracking item 68 can include information compatibility data for the various sub-components.

The software that uses the tracking information can be configured to scan the tracking item 68 associated with housing 62 and measurement components 66 and verify that the proper measurement components 66 are installed inside the housing 62. Similarly, the tracking element 68 associated with the register 64 can be used to verify the measurement components 66 are compatible with the register 64.

### Meter Test Data

The second data type considered is the meter test data. Exemplary meter type data is provided in Table 2 below.

TABLE 2
Meter Test Data

| Name | Description |
|---|---|
| Meter Serial/ID Number | Meter identification information |
| Last Date Tested | Date of last test |
| Previous Register Reading | The number displayed by the meter's |
| | register during a pervious test. |
| Current Register Reading | The current number displayed by the |
| | meter's register. |
| Current Usage Data | Indicates how much fluid flow the meter |
| | has measured since its last test |
| Running Total of Usage Data | Indicates how much fluid flow the meter |
| | has measured since being put into service. |
| Test Count | Number of times the meter was tested for |
| | the current tests |
| Passed/Failed | Flag indicating if meter passes or fails |
| Average Error | The average error defined as the difference |
| | between MUTs measured volume and the |
| | reference volume |
| Certification Status | The Certification Status of the meter |

As depicted in Table 2 above, exemplary meter test data includes meter identification information, the date last tested, previous register reading, current register reading, current usage data, running total of usage data, test count, pass/fail flag, average measurement error and meter certification status.

### Meter Environmental Data

Ideally, meter environmental data includes the location where the meter is installed (e.g., GPS coordinates), fluid quality data, and meter mounting position. Meter environmental data can be any data related to the environment the MUT 34 was or will be subjected to during use. Table 3 below lists exemplary meter environmental data.

TABLE 3
Meter Environmental Data

| Name | Description |
|---|---|
| Location | The location where the meter is installed |
| | or will be installed; an example would be |
| | global positioning (GPS) data; |
| Mounting Position | Mounting position can affect the way a |
| | meter wears over time. Examples include |
| | horizontal and vertical data. |
| Fluid Quality Data | Deposition value; suspended solid value; |
| | Specific Conductance (mS/cm), pH, |
| | Dissolved Oxygen (mg/l), Salinity (ppt), |
| | Turbidity (NTU), Ammonium(a) (mg/l-N), |
| | Nitrate (mg/l-n), Chloride (mg/l), Total |
| | Dissolved Gas (mmHg), Transmissivity, |
| | Ambient Light (μmol s-1 m-2), Chlorophyll |
| | (μg/l); |
| Minimum Temperature | The temperature can be provided by the |
| Maximum Temperature | meter or a general temperature for the |
| Average Temperature | location data. |
| User Defined | User Defined data |

### Test System Data

Test System Data is considered next. As noted above, the platform 10 comprises a plurality of test bench systems characterized by test system data. One example of a test bench system is the exemplary fluid meter test system 12 described above. Such a test system includes a collection of technologies combined to generate meter data, including fluid meter accuracy data. One purpose of test system data is to allow platform 10 to generate a meter data quality indicator/value, which is an indication of the validity of the associated meter data.

Preferably, the fluid meter test system 12 has been tested and certified to comply with a predefined regulatory standard to provide traceability to such standards. Examples include the National Institute of Standards and Technology (NIST). Further, the test technicians are evaluated to verify the test technicians know how to accurately use the fluid meter test system 12. Thus, exemplary test system data includes a list of the technologies and their individual calibration status and the standard to which they are tested to verify compliance. Also included is a list of test technicians that have been evaluated and deemed to have the ability to componentry use the fluid meter test system 12.

The test system data may also include the test process used by a test technician. For example, the test system may be evaluated to verify that the test technicians and test system hardware and software are capable of accurately testing fluid meters to the ISO/AWWA C715 standard. Any test process may be evaluated, and a data confidence value assigned to the associated data using such a process. For example, if meter data is generated by (a) a test system with current calibrations for all hardware components (i.e., a certified test system), (b) has the latest material hardware and software upgrades, and (c) is operated by verified technicians, the meter data would be given a meter data quality value of “High.” Exemplary data quality values would range from High to Medium to Low. Any suitable method for identifying data quality may be used, including numbers. Such data quality value would preferably be associated with meter data transferred to the centralized data storage system for the meter under test 34.

### A Posterior Database—Meter Profiles

The centralized database stores important information about each meter, creating detailed profiles or enabling the creation of such profiles. The system software that manages this data can be installed locally on a computer, accessed remotely over a network (“software as a service”), or a combination of both. By combining information about the meter itself, its test results, and the environment it operates in, the system develops a comprehensive understanding of each meter's performance. These meter profiles can range from simple to complex, providing valuable insights for maintenance and analysis.

Meter data, which includes information about the meter type, test results, and the environment it operates in, may be combined with test system data in a centralized storage system. This creates what's called an A Posterior Meter Database (APM Database). This database provides valuable insights into meter performance based on real-world observations and experience. By analyzing this data, the APM Database can provide a range of dependability and accuracy values for meters used in various environments around the world creating a meter profile of sorts. This analysis includes important metrics like the mean time between failures (MTBF), how this MTBF varies across different environments, and how accuracy changes over time and with usage. Essentially, this database allows for a comprehensive understanding of meter performance based on actual field data.

### Mobile/Portable Test Bench

Attention now is directed to one embodiment of a mobile/portable test system 100. Mobile test system 100 may comprise a primary flow channel (102a-e) comprising a plurality of primary flow sections wherein one section comprises a primary reference meter (104). The primary flow channel further defines a system input (106) at one end and a system output (108) at a second end where the system input (104) is in fluid communication with the output of a flow meter under test at its installation site (not shown). The input of the flow meter is associated with a user (meter owner) fluid source. Alternatively, the system input (106) may be connected to a test fluid source, which may or may not be supplied by a user (meter owner). The system 100 output (108) may in fluid communication with a test fluid receiver (such as a customer service line, or a tank or just an area of ground). A test fluid flows from the fluid source, through the flow meter under test, through the primary reference meter (104) and to the test fluid receiver. Thus, the primary reference meter (104) is downstream from the system input (106) and upstream to the system output (108). As noted above, the primary output defines the primary flow channel (102) “free end” that is in fluid communication with a fluid receiver. An electronic primary valve (110) is disposed in the primary flow path (102) down stream from the primary reference meter (104) and upstream from the system output (108). The primary valve (110) is in electrical communication with a controller (112) allowing the primary valve (110) to be automatically controlled using a computing device.

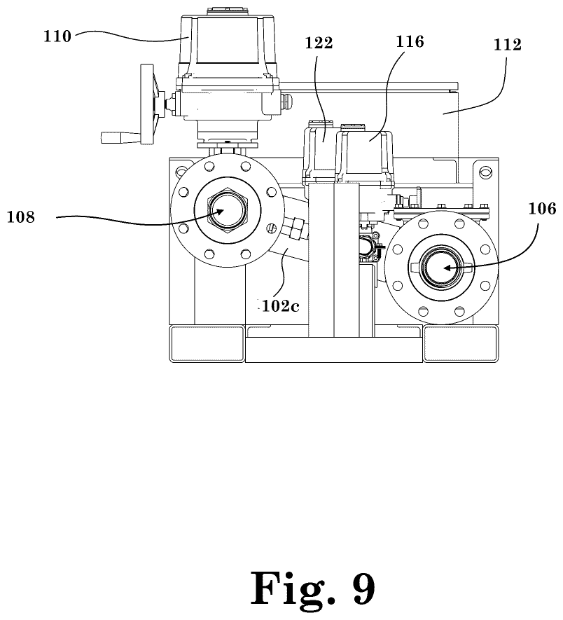

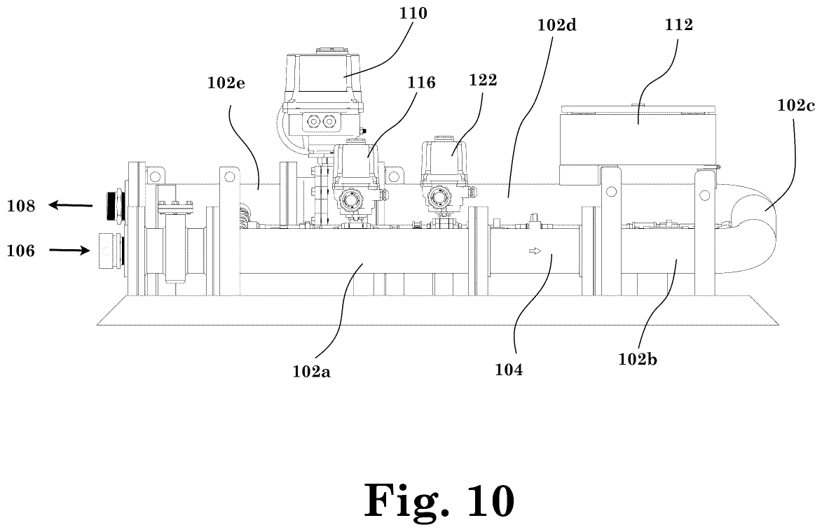

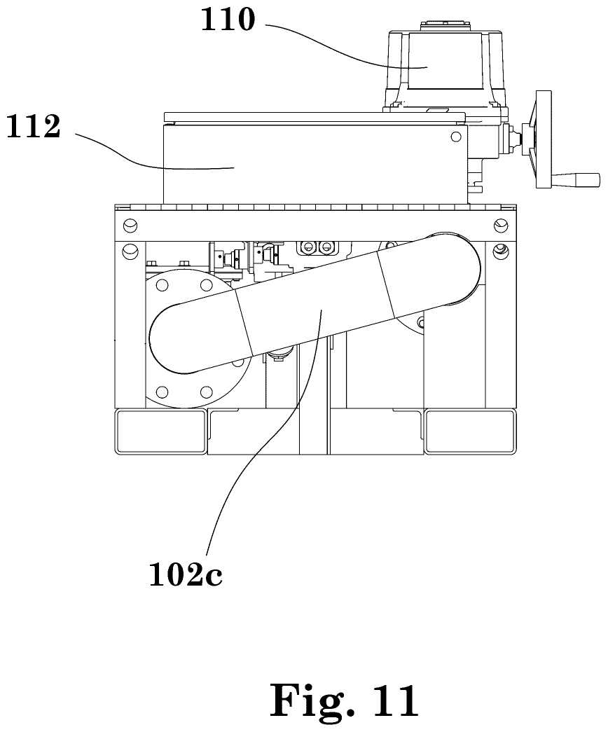

As described above, the mobile fluid meter test system (100) is designed to be compact and portable, fitting onto a vehicle like a truck. Thus, as shown in FIG. 1, the system may be configured in a “U” shape. Further, to facilitate drainage, the system elevates the primary output (108) higher than the primary input (106), creating an incline (see FIG. 9). This design allows the system to automatically drain the test fluid from the primary input (106) after testing is complete, as may be directed by the system's control logic.

The Mobile Test System (MTS) (100) further comprises at least one primary pressure sensor (not shown) in fluid communication with the test fluid in the primary flow path (102) and in electronic communication with a computing device (such as controller 112) to provide pressure measurements of the fluid in the primary flow path.

The MTS (100) further comprises a controller comprising a processing device in communication with at least one of a local memory (on processor memory or a memory in the controller connected to the processor, etc.) or a centuralized database (14). The controller is further in communication with the primary reference meter (104), the primary valve (110) and the primary pressure sensor. A first logic stored in one of the local memory or the centuralized database (14). The processing device may be configured to execute the first logic to perform a plurality of functions including controlling the primary valve (110) data from the primary pressure sensor to automatically maintain a predefined flow rate for the test fluid flowing through primary flow path (102) during a primary flow test. The processor may further use the first logic to determine when the testing process has ended and stop the test after which the test fluid drains out the system input (106).

For example, the processor may use a proportional integral loop to maintain a predefined flow rate. A proportional-integral loop is a type of feedback control system that is commonly used in industrial and engineering applications to regulate processes and maintain desired output levels. The primary control valve (110) can be incrementally opened and closed to adjust flow through the valve. The processor continuously measures the difference between the desired flow rate and the actual flow rate and adjusts the primary flow valve (110) as needed. The controller may further include a communication device electrically associated with the processor so that the processor may transmit real time testing data (EUT data) to a remote device.

The mobile fluid meter test system (100) may further comprise a second flow path comprising a second flow channel (114) defining a second channel diameter that is smaller than the primary diameter. For this embodiment, the second flow channel input (114a) is connected to primary channel section 102c and the second flow channel output (114c) may be connected to primary channel section 102e down stream of the primary valve (110) and upstream of the system output (108). The second flow channel valve (116) may be disposed along the second flow channel downstream from the second channel input (114a) and upstream from the second channel output (108). A second reference meter (118) may be disposed along the second flow channel (114) downstream from the second flow channel input (114a) and upstream from the second flow channel valve (116). A second pressure sensor may be disposed in the second flow channel (114) in fluid communication with the test fluid in the second flow channel (114). The second pressure sensor and the second flow channel valve (116) may be in electrical communication with the controller (112) processing device. As with the primary channel (114), the controller (112) may be configurted to execute the first logic to control the primary valve (110) and the second flow channel valve (116) using data from at least one of said primary pressure sensor and the second pressure sensor to automatically maintain a predefined flow rate for the test fluid flowing through the second reference meter (118), the primary flow channel (114) and the second flow channel (114) during a secondary flow test.

The mobile fluid meter test system (100) may further comprise a third flow path comprising a third flow channel (120) defining a second channel diameter that is smaller than the second flow path diameter. For this embodiment, the third flow channel input (120a) is connected to primary channel section 102c and the third flow channel output (120c) is connected to second channel section 114c down stream of the second flow channel valve (116) and upstream of the system output (108). The third flow channel valve (122) may be disposed along the third flow channel downstream from the third channel input (120a) and upstream from the third channel output (120c). A third reference meter (124) may be disposed along the third flow channel (120) downstream from the third flow channel input (120a) and upstream from the third flow channel valve (122). A third pressure sensor may be disposed in the third flow channel (120) in fluid communication with the test fluid in the third flow channel (120). The third pressure sensor and the third flow channel valve (122) may be in electrical communication with the controller (112) processing device. As with the primary channel (114), the controller (112) may be configurted to execute the first logic to control the primary valve (110), the second flow channel valve (116), and the third flow channel valve (122) using data from at least one of the primary pressure sensor, the second pressure sensor, and the third pressure sensor to automatically maintain a predefined flow rate for the test fluid flowing through the primary flow channel (114), the second flow channel (114) and the third flow channel (122) during a third flow test.

To enhance efficiency, the mobile test system (100) may utilize a centralized database with an AI-powered interface. This AI streamlines the testing process by:
1. Optimizing Test Schedules: The AI intelligently determines the most efficient testing order. It considers various factors, such as the mobile system's current location, prioritizing nearby meters for testing. If a meter has a higher priority due to urgent maintenance needs, the AI will override proximity and schedule that meter first.
2. Simplifying Meter Location: The AI assists the test technicians in finding the correct meter by retrieving and displaying relevant images from the centuralized database or some other data source. This includes pictures of the meter itself, its installation site, and the surrounding location.
3. Automating Test Setup: The AI automatically determines the necessary test parameters based on the meter type and testing requirements. It then configures the system's controller (112) accordingly, eliminating manual setup and reducing the potential for human error.
4. Generating Comprehensive Reports: Once testing is complete, the AI may automatically upload the results to the centralized database. It may also create a detailed profile for each tested meter, containing historical data and performance information as describe above.
   This AI integration significantly improves the speed, accuracy, and overall efficiency of the mobile testing system.

This written description provides a detailed example of how the invention can be implemented. However, it's important to understand that this is just one possible embodiment. Experts in the field will recognize that there are many ways to vary the specifics while still achieving the same core functionality. This could involve using different components, adjusting the arrangement of elements, or modifying the processes involved. Therefore, the invention should not be limited to the exact details described here. Instead, it encompasses all possible variations, combinations, and equivalent implementations that fall within the intended scope and spirit of the invention as defined by the claims.

What is claimed is:

1. A mobile fluid meter test system for testing the accuracy of fluid meters, said mobile fluid meter test system comprising:
a primary flow channel defining a primary channel diameter and comprising a plurality of primary sections;
a primary input defined at one end of said primary flow channel and configured to be placed in fluid communication with at least one of (a) the output of a meter under test (MUT) connected to a test fluid source, and (b) a test fluid source;
a primary output defined at the free end of said primary flow channel and in fluid communication with output point;
a primary reference meter associated with said primary flow channel downstream from said primary input and upstream from said primary output;
a primary valve associated with said primary flow channel downstream from said primary reference meter and upstream of said primary output so that said primary valve can selectively restrict the test fluid flowing through said primary flow channel;
a primary pressure sensor in fluid communication with the test fluid in said primary flow channel;
a controller comprising a processing device in communication with at least one of a local memory or a centuralized database, said primary reference meter, said primary valve and said primary pressure sensor; and
a first logic stored in one of said local memory or said centuralized database; and
wherein said processing device is configurted to execute said first logic to:
(a) control said primary valve using data from said primary pressure sensor to automatically maintain a predefined flow rate for the test fluid flowing through said primary flow channel during a primary flow test;
(b) determine when said testing process has ended and stop the test; and
wherein the test fluid drains out the input of the system after the testing is completed.

2. The mobile fluid meter test system as in claim 1, wherein said controller is configurted to execute said first logic to automatically maintain said predefined flow rate further using said primary reference meter data.

3. The mobile fluid meter test system as in claim 2, wherein said controller is configurted to execute said first logic to use a proportional integral loop to maintain said predefined flow rate.

4. The mobile fluid meter test system as in claim 1, further comprising communication circuits connected with said processing device for communicating real time test data to remote devices.

5. The mobile fluid meter test system as in claim 4, wherein said processing device is configured to communicate with said EUT and transmit real time EUT data to a remote device.

6. The mobile fluid meter test system as in claim 1, wherein said primary output is elevated relative to said primary input, and wherein the primary channel defines an incline from said primary input to said primary output, and wherein said processing device is further configurted to execute said first logic to control said primary valve to automatically drain the test fluid from said primary flow channel.

7. The mobile fluid meter test system as in claim 1, further comprising:
a second flow channel defining a second channel diameter;
a second flow channel input in fluid communication with said primary flow channel downstream from said primary reference meter and upstream from said primary valve;
a second channel output in fluid communication with said primary flow channel downstream from said primary valve and upstream from said primary output;
a second valve disposed along said second flow channel downstream from said second channel input and upstream from said second channel output;
a second reference meter disposed along said second flow channel downstream from said second flow channel input and upstream from said second valve;
a second pressure sensor in fluid communication with the test fluid in said second flow channel;
wherein said controller is further electrically associated with said second valve and said second pressure sensor; and
wherein said controller is configurted to execute said first logic to control said primary valve and said second valve using data from at least one of said primary pressure sensor and said second pressure sensor to automatically maintain a predefined flow rate for the test fluid flowing through said primary flow channel and said second flow channel during a secondary flow test.

8. The mobile fluid meter test system as in claim 1, further comprising:
a third flow channel defining a third channel diameter;
a third channel input in fluid communication with said primary flow channel downstream from said second channel input and upstream from said primary valve;
a third channel output in fluid communication with said second flow channel downstream from said second valve and upstream from said second channel output;
a third valve disposed along said third flow channel downstream from said third channel input and upstream from said third channel output;
a third reference meter disposed along said third flow channel downstream from said third flow channel input and upstream from said third valve;
a third pressure sensor in fluid communication with the test fluid in said third flow channel;
wherein said controller is further electrically associated with said third valve and said third pressure sensor; and
wherein said controller is configurted to execute said first logic to control said primary valve, said second valve, and said third valve using data from at least one of said primary pressure sensor, said second pressure sensor, and said third pressure sensor to automatically maintain a predefined flow rate for the test fluid flowing through said primary flow channel, said second flow channel, and said third flow channel during a third flow test.

9. The mobile fluid meter test system as in claim 1, wherein the first logic is in communication with an AI routine that consults a database to determine the meter tro be tested.

10. The mobile fluid meter test system as in claim 9, wherein the AI further determines directions to the location of the meter to be tested.

11. The mobile fluid meter tester system as in claim 9, wherein the AI determines if a picture of at least one of the meter or the location of the meter and presents the picture to a remote device.

12. The mobile fluid meter tester system in claim 9, wherein the AI determines the test parameters for the testing to be performed and automatically setsup said controller consistent with said test parameters.

13. The mobile fluid meter tester system in claim 9, wherein the AI determines the test parameters for the testing to be performed and automatically setsup said controller consistent with said test parameters.

14. The mobile fluid meter tester system in claim 9, wherein the AI automatically reports the test results to said centuralized database.
